(19) United States
(12) Patent Application Publication
(10) Pub. No.: US 2025/0170661 A1
(43) Pub. Date: May 29, 2025

(54) Hand-Held Battery-Operated Electric Machining Device and Machining System

(71) Applicant: Andreas Stihl AG & Co. KG, Waiblingen (DE)

(72) Inventors: Jonas LANK, Winnenden (DE); Stefan SEIZ, Brackenheim (DE)

(21) Appl. No.: 18/960,659

(22) Filed: Nov. 26, 2024

(30) Foreign Application Priority Data
Nov. 27, 2023 (DE) 10 2023 133 076.4

(51) Int. Cl. B23D 57/02

(52) U.S. Cl. CPC B23D 57/023

(57) ABSTRACT

A hand-held battery-operated electric machining device, includes: a standing plane and a standing portion, a receiving device, wherein the receiving device has a receiving space extending along a receiving direction of the receiving device and designed to be complimentary to the battery pack, a housing portion facing a tool, and a tank which delimits a tank interior of the electric machining device to store a lubricant. The receiving space has a cross-sectional area extending parallel to the standing plane. The cross-sectional area has two long sides extending along a longitudinal extension direction of the electric machining device and located substantially in parallel opposite one another, and two narrow sides extending at right angles to the longitudinal extension direction and located substantially in parallel opposite one another. The two narrow sides extend substantially parallel to the housing portion facing the tool, wherein viewed at right angles to the standing plane, the tank and the receiving device are arranged beside one another at right angles to the longitudinal extension direction.

### CROSS REFERENCE TO RELATED APPLICATION

This application claims priority under 35 U.S.C. § 119 from German Patent Application No. 102023133076.4, filed Nov. 27, 2023, the entire disclosure of which is herein expressly incorporated by reference.

### BACKGROUND AND SUMMARY

The invention relates to a hand-held battery-operated electric machining device and a machining system having such an electric machining device.

It is an object of the present invention to provide a hand-held battery-operated electric machining device and a machining system having such an electric machining device which have in each case improved properties.

This object is achieved by the subject matter of the independent patent claims. Preferred embodiments are the subject matter of the dependent patent claims.

A hand-held battery-operated electric machining device according to the invention has a standing portion in particular having stand feet, and a standing plane, wherein the standing portion is designed for, in particular point and/or linear and/or surface, contact with a substrate in the standing plane. If the substrate on which the electric machining device is placed is designed to be flat, the standing plane can substantially correspond to the substrate.

The electric machining device has a receiving device, which is designed to exchangeably receive an electric battery pack. The receiving device is designed to exchangeably receive the battery pack in a receiving direction of the receiving device, wherein the receiving device has a receiving space that extends along the receiving direction and is designed to be substantially complementary to the battery pack. “Along something” in the present connection can mean “substantially parallel to something”. In particular, the receiving space is designed to be complementary to at least one region of the battery pack to be received, which region fills the receiving space when the battery pack is received.

The electric machining device additionally has a housing portion facing a tool. The housing portion can face a drivable tool device for the electric machining device. The electric machining device can have a tool attachment device which is used for the releasable attachment of the tool device. The housing portion facing the tool can face the tool device when the tool device is attached, in particular releasably, to the electric machining device. The housing portion facing the tool can be arranged, in particular directly, on the tool attachment device.

The electric machining device has a longitudinal extension direction, in particular wherein the electric machining device extends longitudinally along the longitudinal extension direction. The housing portion facing the tool can extend transversely, in particular at right angles, to the longitudinal extension direction.

The electric machining device additionally has a tank. On the inside, the tank delimits a tank interior of the electric machining device. The tank interior is designed to store a lubricant. The lubricant can be a lubricating liquid, for example lubricating oil. In particular, the lubricant can be designed and/or provided, in particular exclusively, to lubricate a tool device attached to the electric machining device. An electric drive device of the electric machining device can be suppliable with electrical energy from the received electric battery pack, in order to generate drive power for the attached tool device, in particular so that a workpiece can be machined by means of the electric machining device in a material-removing and/or separating manner by means of the driven tool device.

The receiving space of the receiving device has a cross-sectional area which extends parallel to the standing plane. The cross-sectional area has two long sides extending along the longitudinal extension direction of the electric machining device and located substantially in parallel opposite one another. In addition, the cross-sectional area has two narrow sides extending at right angles to the longitudinal extension direction and located substantially in parallel opposite one another. The cross-sectional area can thus be designed to be substantially rectangular. “Substantially rectangular” can refer to the fact that corner regions of the cross-sectional area can be rounded and/or that the long sides and/or the narrow sides can deviate, in particular slightly, from an exactly rectilinear extent.

The narrow sides extend substantially parallel to the housing portion facing the tool. The tank and the receiving device—viewed at right angles to the standing plane—are arranged at least partly beside one another at right angles to the longitudinal extension direction. As a result of this arrangement of the tank and of the receiving device relative to one another, packaging advantages can be achieved which, in particular, permit particularly advantageous utilization of the available overall space.

The electric machining device can be a motor chainsaw.

The battery pack can be an electric accumulator pack. The battery pack can be designed for the, in particular tool-free and/or nondestructive, user-releasable mechanical connection to the electric machining device and/or to be user-replaceable or user-removable, in particular from or out of the electric machining device. In particular, the battery pack can be designed to be carried by the electric machining device.

The battery pack designed as an accumulator pack can have a plurality of accumulator cells. In particular, the accumulator cells can be arranged in a package housing of the accumulator pack. Additionally or alternatively, the accumulator cells can each be individually rechargeable electrochemical-based storage elements for electrical energy. Also additionally or alternatively, the accumulator cells can be lithium-ion accumulator cells. Also additionally or alternatively, the accumulator cells can be the same, in particular of the same type and/or construction. Further additionally or alternatively, an, in particular respective, cell voltage, in particular cell rated voltage, of one, in particular respective one, of the accumulator cells can be a minimum of 2 V, in particular a minimum of 3.6 V, and/or a maximum of 5 V, in particular a maximum of 4.2 V. Also additionally or alternatively, the accumulator cells can be round cells, prismatic cells or pouch cells.

Expediently, the receiving direction is oriented at right angles to the standing plane. In particular, the longitudinal extension direction is oriented parallel to the standing plane. Expediently, the receiving device and the tank overlap each other—viewed parallel to the standing plane and at right angles to the longitudinal extension direction—at least in some regions or completely.

Expediently, the tank and the receiving device are arranged indirectly or directly beside one another.

Expediently, an aspect ratio of the, in particular substantially rectangularly designed, cross-sectional area is greater than 1 and less than or equal to 5. In particular, the aspect ratio of the cross-sectional area is about 1.5.

Expediently, the receiving device has a receiving opening, which opens the receiving space, in particular facing away from the standing plane, to the outside counter to the receiving direction and through which the battery pack to be received can be inserted into the receiving space in the receiving direction.

Expediently, the electric machining device has a handle portion, which in particular extends at a distance from the standing plane of the electric machining device and/or transversely with respect to the receiving direction and/or at an angle to the longitudinal extension direction.

In a refinement of the invention, the receiving device has a receiving device thickness measured at right angles to the longitudinal extension direction and parallel to the standing plane. The tank has a tank thickness measured at right angles to the longitudinal extension direction and parallel to the standing plane, in particular in direct extension of the receiving device thickness. A sum of the receiving device thickness and the tank thickness corresponds substantially to a device thickness of the electric machining device, measured at right angles to the longitudinal extension direction and parallel to the standing plane. In particular, a ratio of the receiving device thickness to the device thickness is substantially 1/2 to 3/4. Alternatively or additionally, a ratio of the tank thickness to the device thickness can be substantially 1/4 to 1/2.

In a further refinement of the invention, the tank has a tank length measured along the longitudinal extension direction. The receiving device has a receiving device length measured along the longitudinal extension direction. The tank length and the receiving device length are substantially equally large.

Expediently, a tank internal volume can be 0.1 to 0.4 liters. A receiving space volume can be 0.2 to 1.3 liters.

In a further refinement of the invention, the tank has at least one, in particular transparent, viewing window for the visual detection of a level of stored lubricant. The at least one viewing window can be visually detectable from outside along and—alternatively or additionally—at right angles to the longitudinal extension direction. In particular, the level can be detected visually through the viewing window when the electric machining device is placed on the substrate.

In a further refinement of the invention, the tank is designed as an exchangeable, in particular pre-filled, tank cartridge. Thus, refilling of lubricant can be carried out when the tank is removed from the receiving device.

In a further refinement of the invention, the tank has a filling opening, present in particular on a filling nozzle of the tank, for filling lubricant into the tank interior. The electric machining device has a removable cover, in particular in the form of a cap or a plug, to close the filling opening in a lubricant-tight manner.

In a further refinement of the invention, the electric machining device has an, in particular housing-integral, funnel portion for collecting lubricant, in particular spilled beside the filling opening and/or past the filling opening. The funnel portion can be configured to feed the lubricant collected, in particular spilled beside the filling opening and/or past the filling opening, directly to the filling opening and/or to lead same away from the receiving device.

Expediently, the funnel portion widens in the direction of an upper side of the electric machining device. The filling opening can open the tank interior in a manner directed toward the upper side and/or toward the funnel portion.

In a further refinement of the invention, a first distance between the filling opening and the standing plane is smaller than a second distance between the receiving opening and the standing plane. In particular, the first distance and the second distance are measured along the receiving direction. A difference between the second distance and the first distance can yield a difference in height between the receiving opening and the filling opening.

In a further refinement of the invention, the tank has a tank height measured at right angles to the standing plane, in particular starting from the standing plane. The receiving device has a receiving device height measured at right angles to the standing plane, in particular starting from the standing plane. The tank height is smaller than the receiving device height. The resultant height difference between the receiving opening and the filling opening can make undesired spillage of lubricant into the receiving space when refilling with lubricant more difficult.

In a further refinement of the invention, the electric machining device has a user-operable locking device for the releasable locking of the battery pack received on the receiving device. In particular, the receiving space is arranged between the tank and the locking device at right angles to the longitudinal extension direction, in particular viewed in the receiving direction. Accordingly, the locking device can be arranged on an outer side of the electric machining device. In particular, the outer side, on which the locking device is arranged, can lie opposite the tank at right angles to the longitudinal extension direction and parallel to the standing plane. In particular, at least one locking device is arranged on or at an output-drive-side outer side of the electric machining device. The output-drive-side outer side can point away from the user during the hand-held, in particular hand-carried, operation of the electric machining device.

A machining system according to the invention has a hand-held battery-operated electric machining device as described above. To this extent, the advantages of the electric machining device explained previously are also transferred to the machining system. The machining system additionally comprises an electric battery pack for the storage of electrical energy, wherein the battery pack is exchangeably received by the receiving device of the electric machining device. In particular, the battery pack is an accumulator pack. Furthermore, the machining system has a tool device, which is attached, in particular releasably, to the electric machining device and which can be driven while consuming electrical energy from the received battery pack. In particular, the tool device is attached to a tool attachment device of the electric machining device.

Further advantages and features of the invention are gathered from the claims and from the following description of a preferred exemplary embodiment of the invention, which is illustrated with reference to the drawings. Here, the same designations relate to the same or similar or functionally identical components.

It goes without saying that the features mentioned previously and those still to be explained below can be used not only in the respectively specified combination but also in other combinations or on their own without departing from the scope of the present invention.

### BRIEF DESCRIPTION OF THE DRAWINGS

FIG. 1 is a schematic perspective illustration of a machining system having a hand-held battery-operated electric machining device according to an embodiment of the invention;

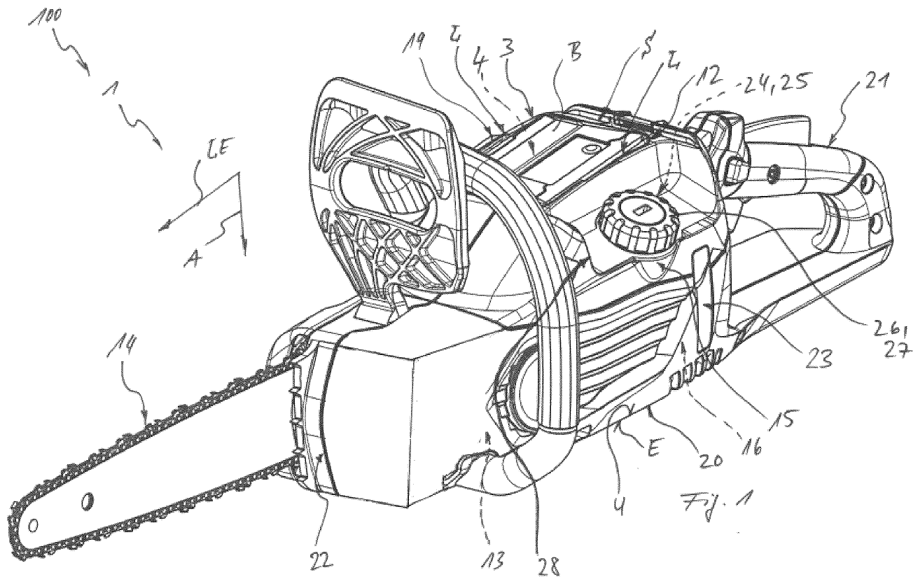

FIG. 2 shows the machining system from FIG. 1 in a schematic top view;

FIG. 3 shows a detail from the top view of FIG. 2; and

FIG. 4 shows the machining system according to FIGS. 1 to 3 in a schematic sectional illustration with respect to a section line C-C.

### DETAILED DESCRIPTION OF THE DRAWINGS

A machining system 100 has a hand-held battery-operated electric machining device 1. The electric machining device 1 in the present case is designed as a motor chainsaw. The machining system 100 also has an electric battery pack B, which is used to store electrical energy. The electric battery pack B of the machining system 100 is exchangeably received by a receiving device 3 of the electric machining device 1. The machining system 100 additionally has a tool device 14, which is attached to the electric machining device 1, detachably in the present case, and which can be driven while consuming electrical energy from the received battery pack B. The battery pack B in the present case is an electrical accumulator pack. The tool device 14 is detachably attached, for example, to a tool attachment device of the electric machining device 1, which is concealed in the figures. In the present case, the tool device 14 has a guide rail and a saw chain guided on the guide rail.

The electric machining device 1 has a standing portion 20 and a standing plane E. The standing portion 20 is designed to contact a substrate U in the standing plane E. The substrate U is not a constituent part of the electric machining device 1. The receiving device 3 of the electric machining device 1 is designed to exchangeably receive the battery pack B. The battery pack B can be received by the receiving device 3 in a receiving direction A of the receiving device 3. The receiving device 3 has a receiving space 4, which extends along the receiving direction A. The receiving space 4 is designed to be substantially complementary to the battery pack. The electric machining device 1 additionally has a housing portion 22 facing a tool.

In particular, the tool device 14 is not a constituent part of the electric machining device 1. In particular, the battery pack B is not a constituent part of the electric machining device 1.

The electric machining device 1 has a tank 15. The inner side of the tank 15 delimits a tank interior 16 of the electric machining device 1. The tank interior 16 is used to store a lubricant. For example, the tool device 14 attached to the electric machining device 1 can be lubricated by means of the lubricant. An electric drive device 13 of the electric machining device 1 can be suppliable with electrical energy from the received battery pack B. The electric drive device 13 can be designed to produce a drive output for the tool device 14 on the basis of electrical energy taken from the accommodated battery pack B. The lubricant can be a lubricating liquid, lubricating oil in the present case, in particular chain oil.

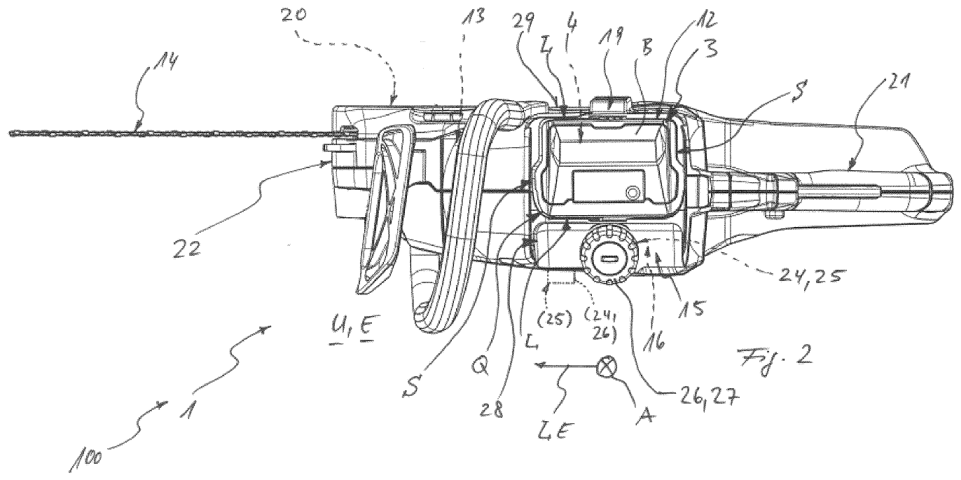

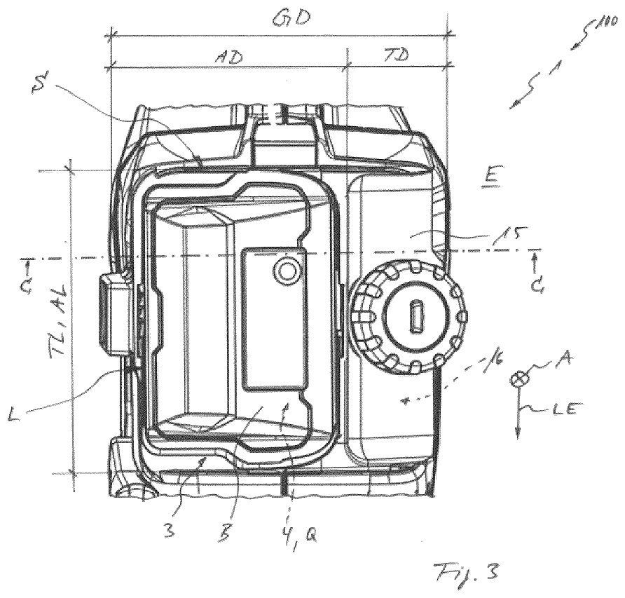

The receiving space 4 has a cross-sectional area Q extending parallel to the standing plane E. The cross-sectional area Q has two long sides L extending along a longitudinal extension direction LE of the electric machining device 1 and located opposite substantially in parallel. In addition, the cross-sectional area Q has two narrow sides S extending at right angles to the longitudinal extension direction LE and located opposite substantially in parallel. The narrow sides S extend substantially parallel to the housing portion 22 that faces the tool. For example, the cross-sectional area Q can be seen in FIGS. 2 and 3 substantially without any perspective distortion. An extent of the narrow sides S is in particular less than an extent of the long sides L.

Viewed at right angles to the standing plane E, the tank 15 and the receiving device 3 are arranged at least partly, completely in the present case, beside one another at right angles to the longitudinal extension direction LE.

In the present case, the receiving direction A is oriented at right angles to the standing plane E. In the present case, the longitudinal extension direction LE is oriented parallel to the standing plane E. Alternatively, the receiving direction A can be oriented transversely to the standing plane E.

Viewed parallel to the standing plane E and at right angles to the longitudinal extension direction LE, the receiving device 3 and the tank 15 overlap, at least in some regions, even completely in the present case. The tank 15 and the receiving device 3 can be arranged indirectly or directly beside one another.

The cross-sectional area Q can be designed to be substantially rectangular, as in the present case. Alternatively or additionally, an aspect ratio of the cross-sectional area Q can be greater than 1 and less than or equal to 5. In the present case, the aspect ratio of the cross-sectional area Q is approximately 1.5.

The receiving device 3 in the present case has a receiving opening 12. The receiving opening 12 opens the receiving space 4 to the outside counter to the receiving direction A, facing away from the standing plane E. The battery pack B can be inserted into the receiving space 4 in the receiving direction A through the receiving opening 12, in order to be received at least partly or-even substantially completely as in the present case-by the receiving device 3.

In the present case, the electric machining device 1 has a handle portion 21. The handle portion can extend longitudinally at a distance from the standing plane E of the electric machining device 1. Alternatively or additionally, the handle section 21 can extend longitudinally transversely to the receiving direction A. Alternatively or additionally, the handle portion 21 can extend along or—as in the present case at an angle—to the longitudinal extension direction LE.

For example, the receiving device 3 has a receiving device thickness AD measured at right angles to the longitudinal extension direction LE and parallel to the standing plane E. The receiving device thickness AD can be measured at a thickest, in particular outer, point of the receiving device 3 at right angles to the longitudinal extension direction LE and parallel to the standing plane E. In the present case, the tank 15 has a tank thickness TD measured at right angles to the longitudinal extension direction LE and parallel to the standing plane E. The tank thickness TD can be measured in direct extension of the receiving device thickness AD. A sum of the receiving device thickness AD and the tank thickness TD in the present case corresponds to a device thickness GD of the electric machining device 1 measured at right angles to the longitudinal extension direction LE and parallel to the standing plane E. In particular, the device thickness GD is measured in the region of the tank thickness TD and of the receiving device thickness AD. A ratio of the receiving device thickness AD to the device thickness GD in the present case is substantially 1/2 to 3/4. Alternatively or additionally, a ratio of the tank thickness TD to the device thickness GD—as in the present case—can be substantially 1/4 to 1/2. “Substantially” can refer to deviations of +/−30%, in particular +/−10%.

In the present case, the tank 15 has a tank length TL measured along the longitudinal extension direction LE. The tank length TL corresponds in particular to a maximum extent of the tank 15 on the outside along the longitudinal extension direction LE. The receiving device 3 in the present case has a receiving device length AL measured along the longitudinal extension direction LE. The receiving device length AL can correspond to an, in particular external, maximum extent of the receiving device 3 along the longitudinal extension direction LE. For example, the tank length TL and the receiving device length AL—as in the present case—are substantially equally large.

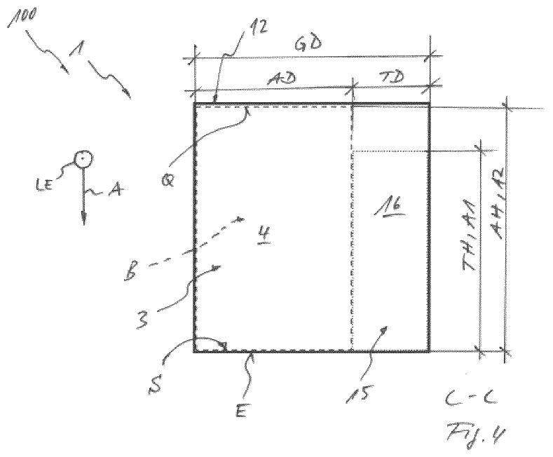

For example, a first distance A1 between the filling opening 25 and the standing plane E is smaller than a second distance A2 between the receiving opening 12 and the standing plane E, cf. in this regard, in particular FIG. 4. The tank 15 has, for example, a tank height TH which is measured at right angles to the standing plane E and, in the present case, corresponds to the first distance A1. In particular, the tank height TH and/or the first distance A1 is measured at the receiving opening 12. The tank height TH and/or the first distance A1 can be measured between a point of the filling nozzle 24, which is furthest removed from the standing plane E, and the standing plane E, in particular when the cover 26 is removed.

The receiving device 3 has, for example, a receiving device height AH measured at right angles to the standing plane E. In the present case, the receiving device height AH corresponds to the second distance A2. The tank height TH is smaller than the receiving device height AH, in particular so that the first distance A1 is smaller than the second distance A2. The receiving device height AH and/or the second distance A2 can be measured, in particular in the immediate vicinity of the tank 15, in particular at the filling opening 25.

For example, the tank 15 has at least one viewing window 23 for the visual detection of a level of stored lubricant. The viewing window 23 can be designed to be transparent. In the present case, the viewing window 23 can be detected visually from outside along and—alternatively or additionally—at right angles to the longitudinal extension direction LE.

In the present case, the tank 15 has a filling opening 25 for filling lubricant into the tank interior 16. The filling opening 25 can be present on a filling nozzle 24 of the tank 15. The electric machining device 1 has, for example, a removable cover 26, which is used to close the filling opening 25 in a lubricant-tight manner. The cover 26 can be designed as a plug and/or—as in the present case—as a cap 27.

In the present case, the electric machining device 1 has a funnel portion 28. The funnel portion 28 is used to collect lubricant. In particular, lubricant spilled beside the filling opening 25 can be collected by means of the funnel portion 28. By means of the funnel portion 28, the collected lubricant can be able to be fed directly to the filling opening 25 and—alternatively or additionally—able to be led away from the receiving device 3. The funnel portion 28 in the present case is designed to be integral with the housing, i.e. the funnel portion 28 can be an integral constituent part of a housing of the electric machining device 1. In the present case, the funnel portion 28 widens in a manner directed toward an upper side of the electric machining device 1. The filling opening 25 can open the tank interior 16 in a manner directed toward the upper side. It is conceivable that the filling opening 25 opens the tank interior 16 to the outside at right angles to the longitudinal extension direction LE and at right angles to the receiving direction A, as indicated dashed in FIG. 2 and with bracketed designations, wherein the electric machining device 1 in this case can have a further standing plane extending at an angle to the standing plane E for the standing of the electric machining device 1. The further standing plane can, for example, be present on an outer side 29 of the electric machining device 1.

For example, the electric machining device 1 has a user-operable locking device 19. The locking device 19 is used, for example, for the releasable locking of the received battery pack B on the receiving device 3. The receiving space 4 can be arranged—as in the present case—at right angles to the longitudinal extension direction LE between the tank 15 and the locking device 19. The locking device 19 can be arranged on the outer side 29 of the electric machining device 1, wherein the outer side 29 is located opposite the tank 15 at right angles to the longitudinal extension direction LE and parallel to the standing plane E.

As an alternative to the embodiment shown, the battery pack B can be designed as a slider battery pack, and the receiving device 3 can be designed appropriately to receive the slider battery pack.

The tank 15 can be designed as an exchangeable or, in particular prefilled, tank cartridge.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand-held battery-operated electric machining device, comprising:
a standing plane and a standing portion, wherein the standing portion is designed for contact with a substrate in the standing plane;
a receiving device for exchangeably receiving an electric battery pack in a receiving direction of the receiving device, wherein the receiving device has a receiving space extending along the receiving direction and configured to be substantially complementary to the battery pack;
a housing section facing a tool; and
a tank, which, on an inside, delimits a tank interior of the electric machining device to store a lubricant,
wherein the receiving space has a cross-sectional area extending parallel to the standing plane,
wherein the cross-sectional area has two long sides extending along a longitudinal extension direction of the electric machining device and located substantially in parallel opposite one another, and two narrow sides extending at right angles to the longitudinal extension direction and located substantially in parallel opposite one another,
wherein the two narrow sides extend substantially parallel to the housing portion facing the tool, and
wherein, viewed at right angles to the standing plane, the tank and the receiving device are arranged at least partly beside one another at right angles to the longitudinal extension direction.

2. The hand-held battery-operated electric machining device according to claim 1,
wherein the receiving device has a receiving device thickness measured at right angles to the longitudinal extension direction and parallel to the standing plane,
wherein the tank has a tank thickness measured at right angles to the longitudinal extension direction and parallel to the standing plane, in a direct extension of the receiving device thickness,
wherein a sum of the receiving device thickness and the tank thickness substantially corresponds to a device thickness of the electric machining device measured at right angles to the longitudinal extension direction and parallel to the standing plane, and
wherein a ratio of the receiving device thickness to the device thickness is substantially 1/2 to 3/4 and/or wherein a ratio of the tank thickness to the device thickness is substantially 1/4 to 1/2.

3. The hand-held battery-operated electric machining device according to claim 1,
wherein the tank has a tank length measured along the longitudinal extension direction,
wherein the receiving device has a receiving device length measured along the longitudinal extension direction,
wherein the tank length and the receiving device length are substantially of equal length.

4. The hand-held battery-operated electric machining device according to claim 1,
wherein the tank has at least one, transparent, viewing window for visual detection of a level of stored lubricant,
wherein the at least one viewing window is detectable visually from outside along and/or at right angles to the longitudinal extension direction.

5. The hand-held battery-operated electric machining device according to claim 1,
wherein the tank is an exchangeable tank cartridge.

6. The hand-held battery-operated electric machining device according to claim 1,
wherein the tank has a filling opening, present on a filling nozzle of the tank, for filling lubricant into the tank interior,
wherein the electric machining device has a removable cover for closing the filling opening in a lubricant-tight manner.

7. The hand-held battery-operated electric machining device according to claim 6,
wherein the electric machining device has a housing-integral, funnel portion for collecting lubricant, wherein, by way of the funnel portion, the collected lubricant can be fed directly to the filling opening and/or can be led away from the receiving device.

8. The hand-held battery-operated electric machining device according to claim 6,
wherein a first distance between the filling opening and the standing plane is smaller than a second distance between a receiving opening of the receiving device and the standing plane.

9. The hand-held battery-operated electric machining device according to claim 1,
wherein the tank has a tank height measured at right angles to the standing plane starting from the standing plane,
wherein the receiving device has a receiving device height measured at right angles to the standing plane starting from the standing plane,
wherein the tank height is smaller than the receiving device height.

10. The hand-held battery-operated electric machining device according to claim 1,
wherein the electric machining device has a user-operable locking device for releasable locking of the battery pack received on the receiving device,
wherein the receiving space is arranged between the tank and the locking device at right angles to the longitudinal extension direction.

11. A machining system, comprising:
a hand-held battery-operated electric machining device according to claim 1;
an electric battery pack for storing electrical energy, wherein the battery pack is exchangeably received by the receiving device of the electric machining device; and
a tool device, which is attached to the electric machining device and which is driven while consuming electrical energy from the received battery pack.
